(19) United States
(12) Patent Application Publication
(10) Pub. No.: US 2010/0017322 A1
(43) Pub. Date: Jan. 21, 2010

(54) Confidential Order Entry for an Equity Offering

(76) Inventors: C. Cullom Davis, Woodside, CA (US); Medha Chadha, Tarrytown, NY (US); Julian Eyles, Gloucester (GB); Nicholas S. J. Greenway, Guildford (GB); David A. Hermer, New York, NY (US); Kristin R. Roth, New York, NY (US); Ross Mitchell Weiner, San Mateo, CA (US)

Correspondence Address: KING & SPALDING, 1180 PEACHTREE STREET , NE, ATLANTA, GA, 30309-3521, US

(21) Appl. No.: 12/463,917

(22) Filed: May 11, 2009

Related U.S. Application Data
(60) Provisional application No. 61/052,135, filed on May 9, 2008.

(51) Int. Cl. G06Q 40/00

(52) U.S. Cl. 705/37

(57) ABSTRACT

Confidential entry of orders to purchase company shares in an equity offering can include an order entry module, order book module, and security module. The order entry module receives orders directly from investors to purchase shares of the company. Each order includes order information such as an identity of the investor that submitted the order, share price, and quantity of company shares to be purchased at the share price. The order book module communicates the order information to members of a management/equity capital markets company team for the equity offering transaction. The security module allows the order entry module to receive the orders directly from the investors, allows the order book module to communicate the order information to the members of the management/company team, and prevents communication of the order information to sales persons associated with the equity offering transaction.

### RELATED APPLICATION

This application claims priority to U.S. Provisional Patent Application No. 61/052,135, filed May 9, 2008 and entitled “Size Price On-Line Entry System for Initial Public Offering Auctions.” The complete disclosure of the above-identified provisional patent application is hereby fully incorporated herein by reference.

### TECHNICAL FIELD

The present invention relates to initial public offerings and follow-on offerings of company shares. More particularly, the present invention relates to confidential investor entry, editing, and deletion of orders to purchase company shares in an equity offering, particularly for an initial public offering.

### BACKGROUND

FIG. 1 is a diagram illustrating a conventional method for taking orders for company shares in an initial public offering. As illustrated, one or more sales persons 102a-n interact with one or more investors 104a-n, to articulate the investment thesis to the investors 104a-n to purchase shares in the company that is the subject of the initial public offering. In this interaction, the sales persons 102a-n provide sales information regarding the company, such as a prospectus, to the prospective investors 104a-n, and the investors 104a-n submit orders for the company shares to the sales persons 102a-n. Then, the sales persons 102a-n enter the orders into an order book 106. The order book 106 includes a record of all received orders, including the proposed share price, quantity of shares ordered at each share price, and the investor making the order.

Members 108 of a transaction management and company team have access to the order book 106 to review orders, including the price and number of shares for each order, and to determine the clearing price for the offering. Exemplary members 108 include members of an equity capital markets team running the initial public offering and management members of the company that is the subject of the initial public offering.

In this conventional model illustrated in FIG. 1, each sales person 102a-n takes the orders directly from one or more of their investor clients 104a-n. Accordingly, the sales persons 102a-n have complete knowledge of specific orders that they receive from the investors 104a-n, including the corresponding share prices and quantities included in those orders. Each sales person 102a-n is informed about interest and investment strategy for their investor clients 104a-n that have submitted orders and for whom they are responsible as firm clients, including the investor identity, share price, and share quantity included in each order. With the knowledge of information from received orders, the sales persons 102a-n can share certain non-confidential information with other sales persons 102a-n and/or their investor clients 104a-n.

This discussion of information among the sales persons 102a-n and their investor clients 104a-n can lead to several potential deficiencies in conventional initial public offering order entry systems. For example, the sharing of information among investors 104a-n and/or sales persons 102a-n can affect the share price in an order and the quantity of shares ordered for a particular share price.

The clearing price is the highest price at which the shares will be sold based on share orders in the initial public offering. In other words, the clearing price is the price at which the number of shares offered by the company equals the number of shares demanded by the investors 104a-n. The sharing of information could influence the clearing price by creating a perception regarding the valuation of the shares, and that valuation may not reflect the potential market value of the shares. Such perception may create price limits that are vague and that may be outside of a desired or expected price range.

Accordingly, a need exists in the art for a system and method for conducting an equity offering while maintaining the confidentiality of orders placed by potential investors. Additionally, a need exists in the art for a system and method for conducting an equity offering that can allow the investors to submit orders directly into the order entry system without the knowledge or help of a sales person, thereby protecting the confidentiality of each investor's order(s).

### SUMMARY

The invention can allow the confidential submission of orders from investors to purchase company shares in an equity offering transaction, such as an initial public offering or a follow-on offering. Sales persons can solicit potential investors to submit orders to purchase the company shares. The investors can input orders to purchase the company shares directly into an order entry system for the initial public offering (or follow-on offering). Members of a management/equity capital markets company team conducting the equity offering transaction can access the orders to obtain summary information regarding the orders. The summary information can include a current clearing price for the company shares based on submitted orders, total share demand per type of investor (institutional investors and retail investors), total number of investors (broken down by institutional and retail investors), total share demand at the current clearing price (broken down by institutional and retail investors), and total number of investors at the clearing price (broken down by institutional and retail investors). Additionally, the summary information can include further information regarding the submitted orders, based on price, share quantity, order size, or other order information, such as a list of all investors that have submitted an order, the number of orders submitted by each investor, the share price and share quantity associated with each order of each investor, and various allocation scenarios regarding the clearing price for differing share quantities and prices.

The system prevents the sales persons from accessing the order information. The investors can submit orders into the system without the assistance of the sales persons, and the sales persons cannot review submitted orders of their investor clients or the investor clients of others sales persons. Accordingly, the present invention can prevent or limit the sharing of certain information between sales persons and investors.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a diagram illustrating a conventional method for taking orders for company shares in an initial public offering.

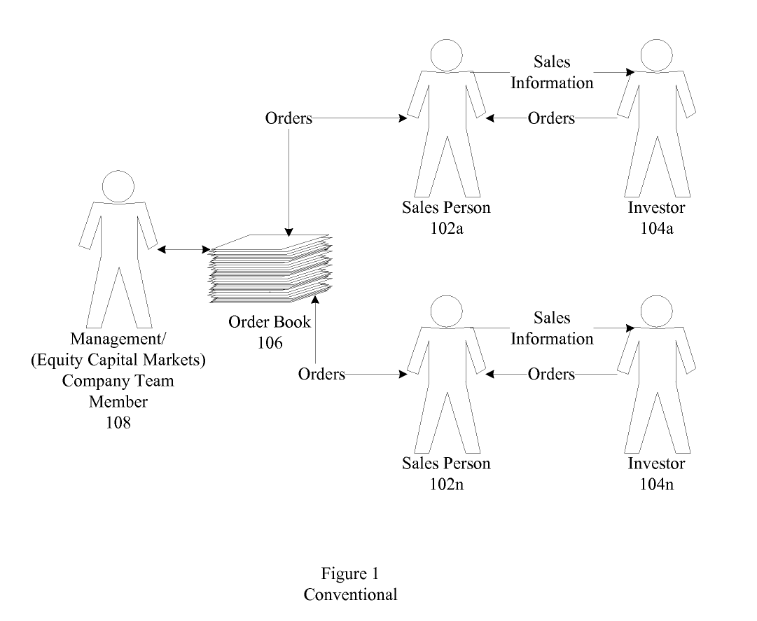

FIG. 2 is a diagram illustrating the operation of an initial public offering order entry process according to an exemplary embodiment of the present invention.

FIG. 3 is a block diagram depicting a system for share order entry and allocation in an equity offering according to an exemplary embodiment of the present invention.

FIG. 4 is a flow chart depicting a method for share order entry and allocation for an equity offering according to an exemplary embodiment of the present invention.

FIG. 5 is a flow chart depicting a method for establishing security controls for the various parties to the order entry and allocation process for the equity offering according to an exemplary embodiment of the present invention.

FIG. 6 is a flow chart depicting a method for controlling access to the order entry system according to an exemplary embodiment of the present invention.

FIG. 7 is a flow chart depicting a method for an investor to input orders directly into the order entry system according to an exemplary embodiment of the present invention.

FIG. 8 is a representative user interface “order book” screen that presents order book and allocation information to members of the management/equity capital markets company team according to an exemplary embodiment of the present invention.

FIG. 9 is a representative user interface “order entry” screen that allows an investor to input, edit, and delete share orders in the order entry system according to an exemplary embodiment of the present invention.

### DETAILED DESCRIPTION OF EXEMPLARY EMBODIMENTS

The present invention can prevent or limit the sharing of order information between investors and sales persons, thereby limiting the effect of such shared information on the share price of company shares in an equity offering, such as an initial public offering transaction or a follow-on offering transaction. Investors can submit orders into an order entry system to purchase the company shares in the equity offering. While members of a management/equity capital markets company team running the transaction can access information regarding the orders submitted by the investors, sales persons are not permitted to access such information. Accordingly, the sales persons do not know whether investors they solicited have submitted an order or any details regarding such orders.

The invention includes a computer program and a computer program product, operating on a computer system, that embody the functions described herein and illustrated in the appended flow charts, such computer program being executed on a computer system by a computer processor coupled to a memory storage device. In exemplary embodiments, the computer program can be embodied in one or more software modules operating and/or stored on a computer system. However, it should be apparent that many different ways of implementing the invention in computer programming may exist, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

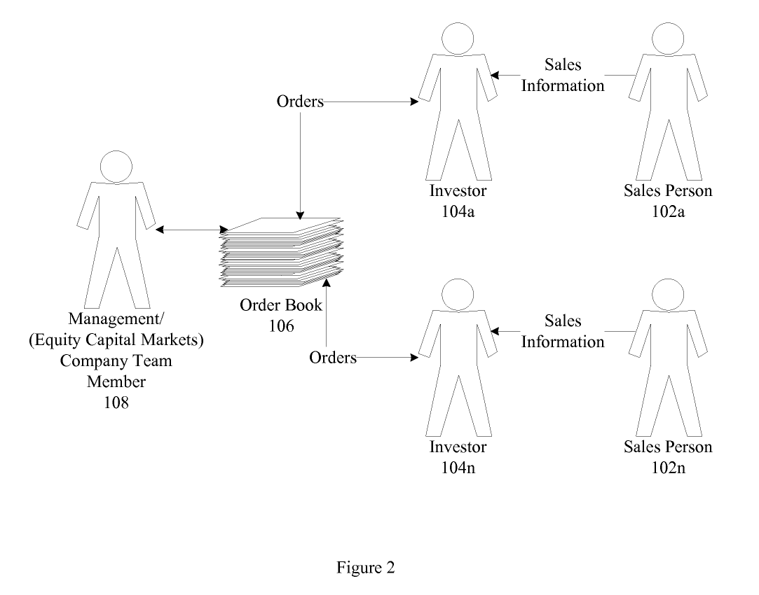

FIG. 2 is a diagram illustrating the operation of an initial public offering order entry process according to an exemplary embodiment of the present invention. As illustrated, sales persons 102a-n provide sales information, such as a prospectus, to investors 104a-n. Investors 104a-n who decide to submit an order to purchase company shares in the initial public offering submit their orders directly into the order book 106. In this case, the order book 106 comprises an electronic form. Then, the investors 104a-n can access their order history in the order book 106 to view, edit, and/or delete their existing orders and also to submit new orders until the end of the initial public offering. Additionally, members 108 of the management/equity capital markets company team can access the order book 106 to view all orders from the investors 104a-n and to analyze potential and actual allocations of the shares to the investors 104a-n.

As illustrated in FIG. 2, sales persons 102a-n have initial contact with the investors 104a-n. However, the sales persons 102a-n do not know whether the investors 104a-n have submitted an order, and they further do not know any details regarding the price or quantity of any order submitted by the investors 104a-n. Accordingly, the investors 104a-n are not influenced by known or speculated orders of other investors 104a-n, including known or speculated prices and quantities in such orders. Additionally, the sales persons 102a-n are not influenced by the orders of the investors 104a-n, including price or quantity of such orders and, therefore, will not influence the investors 104a-n in a similar manner.

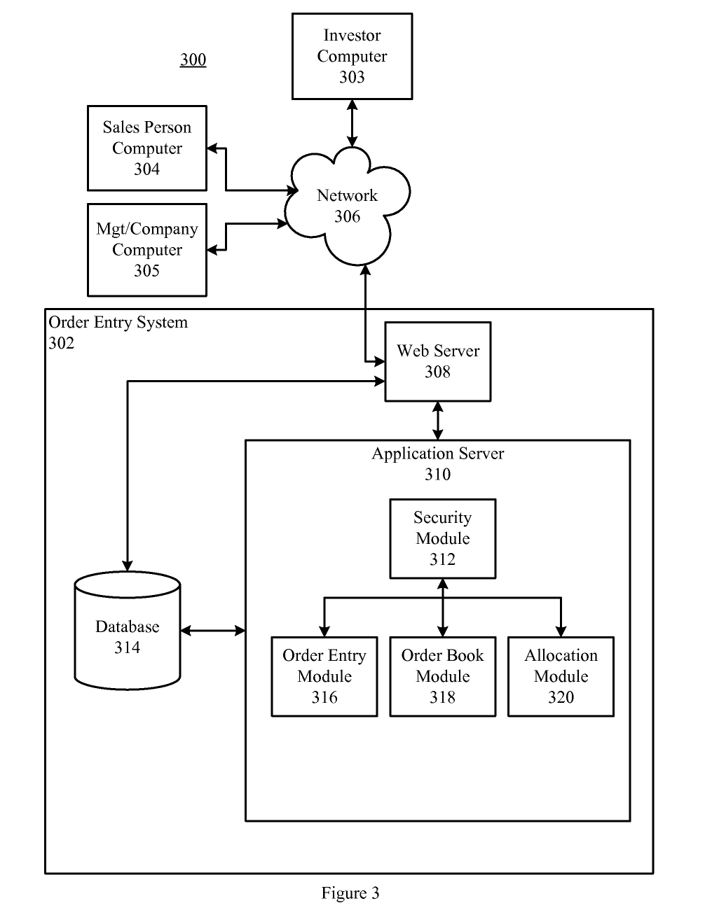

FIG. 3 is a block diagram depicting a system 300 for share order entry and allocation in an equity offering, such as an initial public offering or follow-on offering, according to an exemplary embodiment of the present invention. The exemplary equity offering will be described hereinafter with reference to an initial public offering. As illustrated, the system 300 includes an order entry system 302 that communicates with one or more computers 303-305 via a network 306.

In exemplary embodiments, the network 306 can include any wired or wireless telecommunication device by which computerized devices can exchange data, including, for example, a local area network (LAN), wide area network (WAN), intranet, Internet, or any combination thereof. Additionally, although illustrated in FIG. 3 as a single network 306, the invention contemplates the use of multiple networks 306 to accomplish a similar function. For example, the investor computer 303 may access the order entry system 302 via an Internet type of network 306, and the sales person computer 304 and/or the management/equity capital markets company computer 305 may access the order entry system 302 via an intranet type of network 306. Other combinations and distributions of the computers 303-305 and network 306 are within the scope of spirit of the invention.

The order entry system 302 can include several components for share order entry and allocation for an initial public offering. A web server 308 communicates information to and from the computers 303-305 via the network 306. The web server 308 also communicates information to and from an application server 310 and a database 314 of the order entry system 302.

The database 314 stores information regarding the initial public offering. For example, such information can include a prospectus for the company that is the subject of the initial public offering. The information also can include requirements for share orders from the investors. In exemplary embodiments, share order requirements can include an expected range for the clearing price of a share, a minimum order size (minimum number of shares per order), a minimum increment for the share price for different orders by the same investor, and a maximum number of orders allowed per investor. Additionally, the database 314 also stores information regarding profiles for registered investors 104a-n, sales persons 102a-n, and members 108 of the management/equity capital markets company team, and all information related to orders submitted by the investors 104a-n.

The investors 104a-n can access the order entry system 302 to input an order to purchase company shares in the initial public offering. The investors 104a-n use the investor computer 303 to access the order entry system 302 via the network 306. In this case, the investor computer 303 communicates with the web server 308 of the order entry system 302 via the network 306.

A security module 312 of the application server 310 permits access of the investors 104a-n to order entry functionality only and prevents access of the investors 104a-n to order book functionality. Accordingly, the security module 312 allows an order entry module 316 of the order entry system 302 to present an order entry user interface screen to the investors 104a-n via the investor computer 303 and to receive an order input by one of the investors 104a-n. The order entry module 316 also stores order details in the database 314.

Members 108 of the management/equity capital markets company team can access the order entry system 302 to obtain summary information for all orders input by the investors 104a-n. In this case, the members 108 can use the management/company computer 305 to access the order entry system 302 via the network 306. The security module 318 can permit access of the management/company computer 305 to order book functionality of an order book module 318 in the order entry system 302. In certain exemplary embodiments, the security module 318 can permit or deny access to the order entry module 316 by the management/company computer 305, as desired. The order book module 318 presents the details of existing orders and allocation options to the member 108 of the management/equity capital markets company team via the management/company computer 305.

An allocation module 320 calculates one or more allocation strategies of the company shares based on the orders input by the investors 104a-n and presents the allocation strategies to the members 108 of the management/equity capital markets customer team. In exemplary embodiments, the allocation strategies can include a clearing price and a number of shares to be allocated to each of the investors 104a-n at the clearing price.

The security module 312 also controls access of the sales persons 102a-n to the functionality of the order entry system 302. Specifically, the security module 312 prevents the sales persons 102a-n from using a sales person computer 304 to access the order entry functionality and the order book functionality of the order entry module 316 and the order book module 318, respectively, as well as preventing access to any information related to details of the investors 104a-n and their orders.

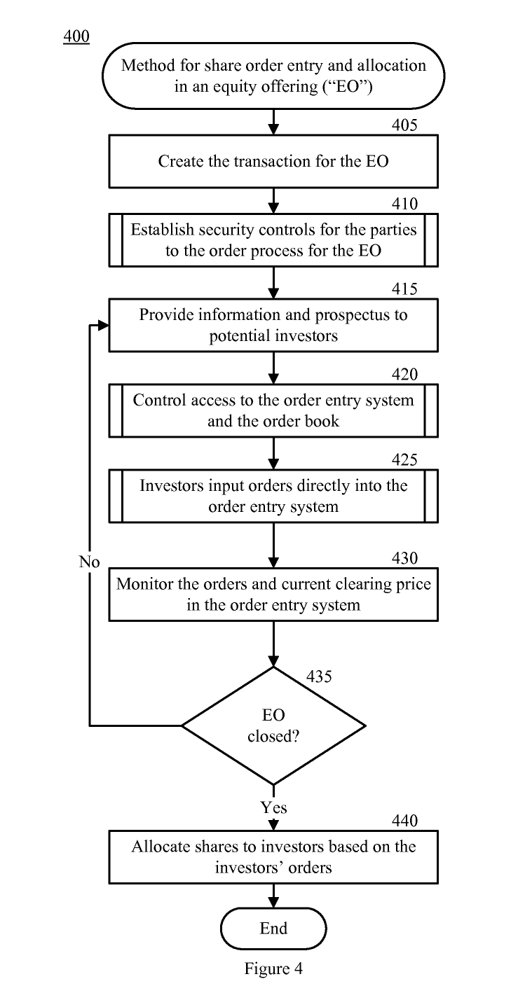

The operation of the system 300 will be described in further detail hereinafter with reference to FIGS. 4-9.

FIG. 4 is a flow chart depicting a method 400 for share order entry and allocation for an equity offering, such as an initial public offering or follow-on offering, according to an exemplary embodiment of the present invention. The method 400 will be described hereinafter with reference to FIGS. 2-4.

In step 405, the members 108 of the management/equity capital markets company team create the transaction that will be the equity offering, such as an initial public offering of follow-on offering, for shares of the company. The exemplary equity offering will be described hereinafter with reference to an initial public offering. In an exemplary embodiment, step 405 can include creating a prospectus, loading the prospectus into the database 314, linking the prospectus stored in the database 314 to the order entry module 316, establishing the expected range for price of shares of the company, establishing a minimum order size (quantity of shares) for each order for each investor, establishing a price increment for multiple orders for an investor, establishing a minimum or maximum number of orders allowed per investor, and/or establishing a minimum and maximum number of shares per order or per aggregate of orders for an investor. The items created in step 405 can be stored in the database for use by the components of the application server 310.

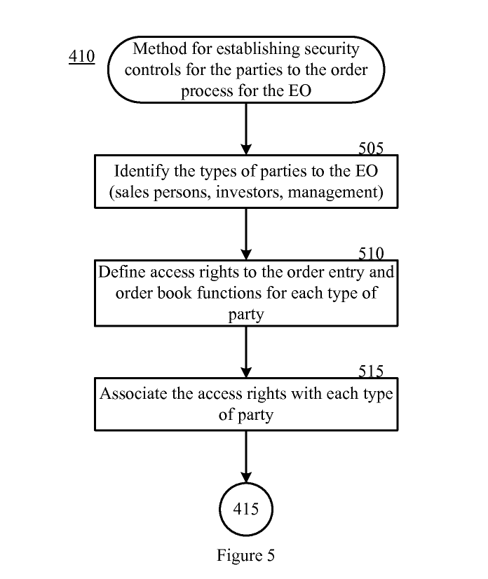

In step 410, the management/equity capital markets company team 108 establishes security control for the various parties to the order entry and allocation process for the initial public offering. The various parties include the sales persons 102a-n, the investors 104a-n, and the members 108 of the management/equity capital markets company team. Each of these types of parties can have different access rights to functionality within the order entry system 302. For example, access of the sales persons 102a-n to the order book, order entry, and allocation functionality of the order entry module 316, the order book module 318, and the allocation module 320, respectively, can be prevented. Additionally, the investors 104a-n can be provided direct access to the order entry functionality of the order entry module 316, while being denied access to order book and allocation functionality of the order book and allocation modules 318, 320, respectively. Members 108 of the management/equity capital markets company team can be allowed access to order book and allocation functionality of the order book and allocation modules 318, 320, respectively. The members 108 of the management/equity capital markets company team also can be allowed access to order entry functionality of the order entry module 316, if desired. The security module 312 controls access of the parties during operation of the system 400. The method 410 will be described in further detail hereinafter with reference to FIG. 5.

In step 415, the sales persons 102a-n provide information regarding the initial public offering, such as a prospectus, to the potential investors 104a-n to attempt to convince the investors 104a-n to submit an order for shares in the company that is the subject of the initial public offering.

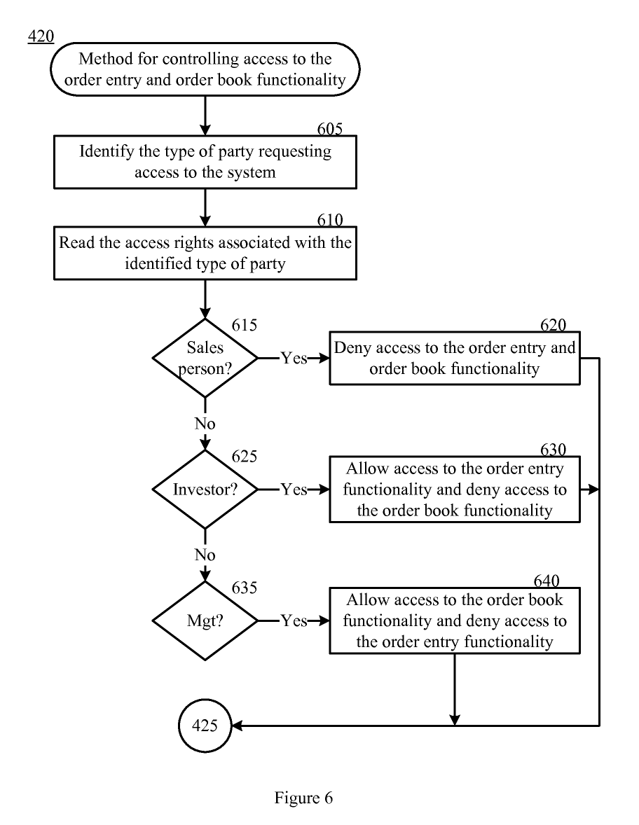

In step 430, the security module 312 controls access to the order entry system 302, including the order book and order entry functionality. In this step, the security module 312 allows or denies access to various functionality of the order entry system, based on the type of party that is trying to access such functionality. Step 420 will be described in further detail hereinafter with reference to FIG. 6.

In step 425, the investors 104a-n input orders directly into the order entry system 302. In this regard, a particular investor 104a can use the investor computer 303 to access the order entry system 302 via the network 306. Specifically, the security module 312 allows the investor computer 303 to access the order entry module 316 to input an order to purchase shares into the order entry system 302. Step 425 will be described in further detail hereinafter with reference to FIG. 6.

In step 430, members 108 of the management/equity capital markets company team monitor the orders submitted by the investors 104a-n and current allocation strategies via the order entry system 302. In this regard, a member 108 of the management/equity capital markets company team can access the order book functionality of the order book module 318 in the order entry system 302. Specifically, the member 108 of the management/equity capital markets company team can use the management/equity capital markets company computer 305 to submit a request for information to the order book module 318 of the order entry system 302. The order book module 318 accesses the order information stored in the database 314 and presents the order information to the member 108 of the management/equity capital markets company team via the management/equity capital markets company computer 305. The order book module 318 also can integrate with the allocation module 320 to present current allocation strategies to the member 108 of the management/equity capital markets company team via the management/equity capital markets company computer 305.

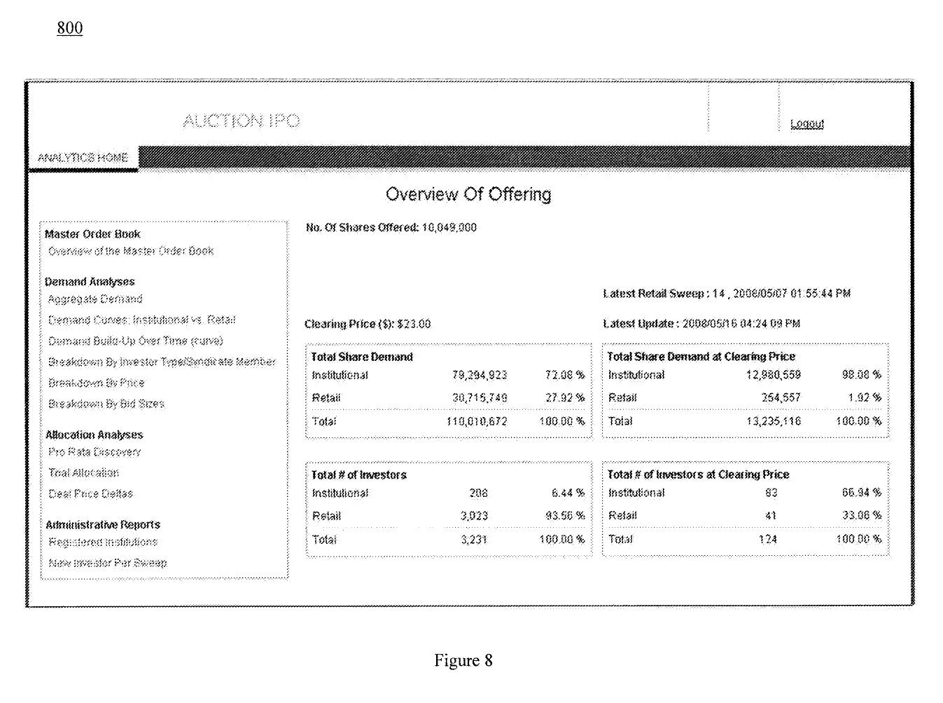

FIG. 8 is a representative user interface “order book” screen 800 that presents order book and allocation information to the members 108 of the management/equity capital markets company team according to an exemplary embodiment of the present invention. In an exemplary embodiment, the order book module 318 can present the order book screen 800 via the management/equity capital markets company computer 305. As illustrated in FIG. 8, the screen 800 states that it is an “overview of offering,” providing summary information for received orders and current allocation strategies.

The screen 800 provides a number of informational items to the members 108 of the management/equity capital markets company team. For example, the screen 800 provides a current “clearing price” indicated as $23.00 in the screen 800. The screen 800 also provides additional information, such as, total share demand per type of investor (institutional investors and retail investors), total number of investors (broken down by institutional and retail investors), total share demand at the current clearing price (broken down by institutional and retail investors), and total number of investors at the clearing price (broken down by institutional and retail investors). Additionally, the screen 800 provides links to other order book summary information available to the members 108 of the management/equity capital markets company team. Such additional information can provide further information regarding the summary of submitted orders, based on price, share quantity, order size, or other order information. In an exemplary embodiment (not illustrated in FIG. 8), the order book information can include one or more of a list of all investors that have submitted an order, the number of orders submitted by each investor, the share price and share quantity associated with each order of each investor, and various allocation scenarios regarding the clearing price for differing share quantities and prices.

In step 435, the method 400 determines whether the time period for accepting orders from the investors 104a-n has ended. If not, the method 400 branches back to step 415 in which the sales persons 102a-n continue to solicit orders from the investors 104a-n, and the method 400 repeats until the initial public offering is closed. When the initial public offering is closed, the method 400 branches from step 435 to step 440. In step 440, the allocation server allocates shares to the investors 104a-n based on the investors' orders.

From step 440, the method 400 ends.

FIG. 5 is a flow chart depicting a method 410 for establishing security controls for the various parties to the order entry and allocation process for the initial public offering according to an exemplary embodiment of the present invention, as referenced in step 410 of FIG. 4. The method 410 will be described hereinafter with reference to FIGS. 2-5.

In step 505, the various types of parties to the initial public offering are identified. For example, types of parties can include sales persons 102a-n, investors 104a-n, and members 108 of the management/equity capital markets company team. Each of these types of parties to the initial public offering can have different access rights based on the desired functionality to be provided to the particular type of party. Accordingly, in step 510, members 108 of the management/equity capital markets company team define the access rights to the order entry, order book, and allocation functionality of the order entry system 302 for each type of party. In an exemplary embodiment, the sales persons 102a-n can be denied access rights to the order entry, order book, and allocation functionality, the investors 102a-n can be provided access rights to the order entry functionality, and the members 108 of the management/equity capital markets company team can be provided access rights to the order book and allocation functionality. In addition, in an exemplary embodiment, the members 108 of the management/equity capital markets company team also can be provided access to the order entry functionality, if desired. Other types of parties can be used in the system or method contemplated by the invention and can be provided corresponding access rights at the system 300.

In step 515, the defined access rights for each type of party are associated with the particular party type. In an exemplary embodiment, this association can be accomplished via a table stored in the database 314. For example, the table can list each type of party and can have associated in the table the corresponding access rights for each type of party.

From step 515, the method 410 proceeds to step 415 (FIG. 4).

FIG. 6 is a flow chart depicting a method 420 for controlling access to the order entry system 302 according to an exemplary embodiment of the present invention, as referenced in step 420 of FIG. 4. The method 420 will be described hereinafter with reference to FIGS. 2-4 and 6.

In step 605, the security module 312 identifies the type of party requesting access to the system. In an exemplary embodiment, the security module 312 can identify the type of party requesting access to the system based on the profile of the party. For example, if an investor 104a is requesting access to the system, the investor's profile will identify that person as having an “investor” type of party. Alternatively, a sales persons profile will identify that person as having a “sales person” type of party. The profile of a member 108 of the management/equity capital markets company team would identify the appropriate type of party for that member 108.

Then, in step 610, the security module 312 reads the access rights associated with the identified type of party for the person requesting access to the order entry system 302. In an exemplary embodiment, the security module 312 can access the table of associated access rights in the database 314 and can read the access rights associated with the identified type of party from that table. Thereafter, the security module 312 grants the appropriate access rights to the party requesting access to the order entry system 302. Thus, in step 615, if the person requesting access is a “sales person” type of party, then the method branches from step 615 to step 620 in which the security module 312 denies access to the order entry, order book, and allocation functionality of the order entry system 302. Alternatively, if the person requesting access is an “investor” type of party, then the method 420 branches from step 625 to step 630 in which the security module 312 allows the investor access to the order entry functionality and denies the investor access to the order book and allocation functionality. If the person requesting access is a member 108 of the management/equity capital markets company team, then the method 420 branches from step 635 to step 640 in which the security module 312 allows access of the member 108 to the order book and allocation functionality and denies access of the member to the order entry functionality. In certain exemplary embodiments, the security module 312 also can grant access for the member 108 to the order entry functionality, if desired. The security module 312 allows access by allowing the particular computer 303-305 to communicate with the corresponding functionality module 316-318. The security module 312 prevents access by not allowing the particular computer 303-305 to communicate with the corresponding functionality module 316-318.

After granting the appropriate access to the person accessing the order entry system 302, the method 420 proceeds to step 425 (FIG. 4).

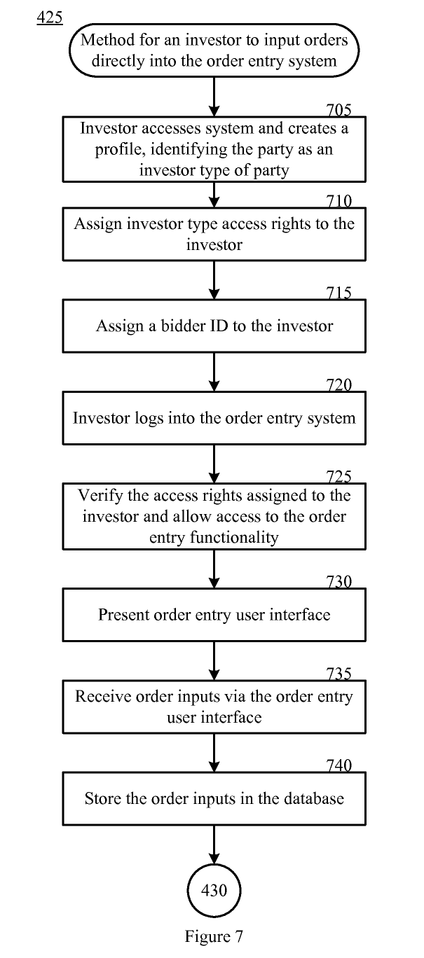

FIG. 7 is a flow chart depicting a method 425 for an investor 104a-n to input orders directly into the order entry system 302 according to an exemplary embodiment of the present invention, as referenced in step 425 of FIG. 4. The method 425 will be described hereinafter with reference to FIGS. 2-4 and 7.

In step 705, an investor 104a uses the investor computer 303 to access the order entry system 302 via the network 306. Specifically, the investor computer 303 communicates the investor's request to the web server 308 of the order system 302 via the network 306, and the web server 308 communicates the request to the security module 312 of the application server 310. In response to the request, the security module 312 communicates a profile entry user interface screen to the investor 104a via the web server 308 for presentation on the investor computer 303. The investor 104a then creates a profile, which can include information such as the type of party (investor, sales person, or management/equity capital markets company team member), investor's name, company name, address, contact information, password, and other information requested by the management/equity capital markets company team. The security module 312 stores the profile information in the database 314.

In step 710, the security module 312 assigns access rights to the investor 104a based on the type of investor identified in the profile created in step 705. In this case, the investor's profile can be flagged as an “investor” type of party, and access rights can be granted to the investor based on the corresponding access rights associated with the “investor” type of party in the database 314.

In step 715, the security module 312 assigns a bidder ID to the investor 104a. The investor uses the bidder ID and password to log into the order entry system 302 in step 720. Then, in step 725, the security module 312 verifies the access rights available to the investor 104a based on the access rights associated with the “investor” type of party in the database 314, and allows the investor to access the order entry functionality of the order entry module 316.

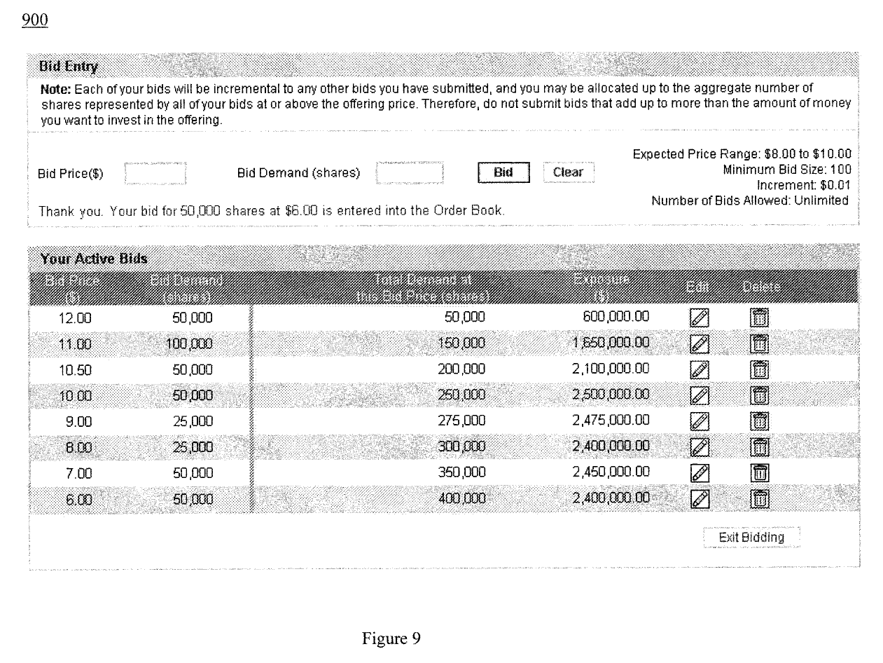

In step 730, the order entry module 316 presents an order entry user interface screen to the investor computer 303 for the investor 104a to input a share order. An exemplary order entry user interface screen will be described in further detail hereinafter with reference to FIG. 9.

In step 735, the order entry module 316 receives order input from the investor 104a via the order entry user interface. Then, in step 740, the order entry module 316 stores the details of the investor's 104 order(s) in the database 314.

From step 740, the method 425 proceeds to step 430 (FIG. 4).

FIG. 9 is a representative user interface “order entry” screen 900 that allows an investor 104a-n to input, edit, and delete share orders in the order entry system 302 according to an exemplary embodiment of the present invention. As shown in FIG. 9, the investor 104a can input a price per share for a new order in the “bid price” field and can input a number of desired shares at the input bid price in the “bid demand” field. After inputting information in the bid price and bid demand fields, the investor can select the “bid” function button to submit the order to the order entry module 316. All existing orders of the investor 104a are listed in the “active bids” section in the lower half of the screen 900. Thus, the investor 104a can review all existing orders and the investor's total exposure based on all existing orders. Additionally, the investor can edit or delete any existing order by selecting the “edit” or “delete” function buttons for specific orders. Near the upper right corner of the screen 900, the order requirements established by the management/equity capital markets company team are presented to guide the investor 104a in submitting proper orders. As shown, the exemplary screen 900 presents an “expected price range” of $9.00 to $10.00, a “minimum bid size” of 100, a bid “increment” of $0.01, and a “number of bids allowed” of unlimited.

The steps 705-710 can be used for any user of any party type to create a user profile, thereby assigning the appropriate access rights to the user. For example, a member 108 of the management/equity capital markets company team can create a profile and can be assigned the appropriate access rights. Additionally, any user of any party type can log into the system according to step 720, and the security module 312 will allow the appropriate access to the user as described in steps 725-730.

Controlling access to submitted orders and the order entry system 302 can have a positive effect on the equity offering process. For example, preventing knowledge of orders by either the sales persons 102a-n and/or other investors 104a-n can increase clarity on pricing due to creation of a more precise demand curve for the shares. This action occurs because the submitted orders may reflect more accurately the actual demand of the investors 104a-n for the shares because those orders are not influenced by information regarding other investors 104a-n. Investors also may be motivated to increase their diligence during the equity offering marketing phase to submit a more specific order (i.e., specific price and shares), thereby creating a longer term focus for the investors. Additionally, the equity offering executed according to the invention has other benefits. The sales persons 102a-n and the entire underwriting group remain motivated to sell orders to the investors 104a-n. The sales persons 102a-n still operate as a conventional sales force by marketing to the investors 104a-n. The difference is that the sales persons 102a-n do not have knowledge of their investors' orders or other sales persons' investors' orders, so they continue their selling efforts throughout the process. Investors may spend more time analyzing the company to create an accurate order absent the conventional order feedback provided by a conventional system. Thus, demand for the company shares is driven by knowledgeable, longer-term investors, which may result in larger allocations to more committed buyers.

As described herein, the order entry system 302 can provide a web-based, on-demand, password-protected order entry portal for investors 104a-n to enter, edit, and delete share orders while the initial public offering is open. The invention provides a secure system in which investors 104a-n can view only their own orders, in which sales persons 102a-n cannot view orders of any investors 104a-n, and in which investors do not have knowledge of other investor activity. This arrangement provides anonymity and protection from potential information sharing, which maintains the integrity of the initial public offering results data.

In exemplary embodiments, the allocation module 320 can allocate the shares to the investors 104a-n based on any desired allocation technique. For example, the allocation module 320 can allocate shares based on an allocation that will provide the highest price per share (clearing price). Alternatively, members 108 of the management/equity capital markets company team 108 can alter the allocation process to provide a desired allocation among the investors. In this case, members 108 of the management/equity capital markets company team may desire to use discretion in the allocation to limit the number of shares allocated to one investor or group of investors. In an exemplary embodiment, the allocation module 320 can allocate shares using a pro-rata formula.

In certain exemplary embodiments, the equity offering can be conducted as an auction. In this case, the investors' orders are submitted as bids to purchase shares at specified prices, and the allocation module allocates the shares accordingly at the close of the auction. In an alternative exemplary embodiment, a “hybrid” approach can be used. In this case, the allocation methodology can be structured to fit the company's objective. For example, the allocation can rely on institutions for price discovery, can limit retail allocation to a fixed percentage, can provide preference to a subset of investors, and/or can make the final allocation of shares in a subjective manner.

Although previously described as the investors 104a-n submitting orders directly into the order entry system 302 via a web site, the invention encompasses other methods for submission of investor orders. For example, investors could submit their orders confidentially to a third party (other than the sales persons 102a-n and the members 108 of the management/equity capital markets company team). Then, the third party can communicate the orders into the order entry system 302, which can be used to analyze the order information and to allocate shares accordingly.

In an alternative exemplary embodiment, the investors 104a-n can submit their orders to another party that aggregates the orders for one or more investors. In this case, the party accepting the orders for the one or more investors submits the orders to the order entry system 302 in a manner similar to the method in which an investor would input an order directly into the order entry system 302. Confidentiality of the orders is maintained by preventing access of the investors to orders of other investors and by preventing access of sales persons to orders of any of the investors. Then, the order entry system 302 can be used to analyze the order information and to allocate shares accordingly.

In the context of an initial public offering, a public trading price for company shares does not yet exist and a market for the company shares does not yet exist. Accordingly, one purpose of an initial public offering is to determine the initial price of shares issued for the company. Discussion among the investors or among the sales persons soliciting the investors can potentially influence the initial public trading price. That influence can either increase the share price or decrease the share price depending on the information that is shared among the parties. For example, if the investors and/or sales persons are discussing information among the parties, the parties may guess at a value of the shares and may submit bids directed at or near that value. The present invention can alleviate this potential issue by maintaining the confidentiality of orders and preventing the potential information sharing issues of conventional initial public offering processes.

As will be appreciated by a person having ordinary skill in the art, one or more of the various steps and processes described herein, either in whole or in part, may be performed by an appropriately configured computer system, such as a computer processor executing instructions embedded in a memory for performing the various steps and processes. The present invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. Various modifications of, and equivalent steps corresponding to, the disclosed aspects of the exemplary embodiments, in addition to those described above, can be made by those having ordinary skill in the art without departing from the spirit and scope of the present invention defined in the following claims, the scope of which is to be accorded the broadest interpretation so as to encompass such modifications and equivalent structures.

What is claimed is:

1. A system for confidential entry of orders to purchase shares of a company in an equity offering, comprising:
an order entry module that receives the orders to purchase shares of a company in an equity offering transaction, the orders comprising order information and originating from one or more computers that are each associated with an investor type of party to the equity offering transaction, wherein the order entry module stores the order information; and
a security module that (1) allows the order entry module to communicate with the one or more computers that are each associated with the investor type of party to thereby receive the orders and (2) prevents communication of the order information to at least one computer that is associated with a sales person type of party to the equity offering transaction.

2. The system of claim 1, further comprising an order book module that accesses the stored order information and that communicates the order information to one or more computers that are each associated with a member of a management/equity capital markets company team for the equity offering transaction,
wherein the security module allows the order book module to communicate the order information to the one or more computers that are each associated with a member of the management/equity capital markets company team.

3. The system of claim 1, further comprising a database that stores access rights that are associated with each type of party to the equity offering transaction, and
wherein the security module reads the access rights associated with the investor type of party to determine to allow the order entry module to communicate with the one or more computers that are each associated with the investor type of party and reads the access rights associated with the sales person type of party to determine to prevent communication of the order information to at least one computer that is associated with the sales person type of party.

4. The system of claim 1, wherein the equity offering transaction comprises an auction format, and wherein the orders comprise an auction bid format.

5. The system of claim 1, wherein the equity offering transaction is an initial public offering.

6. The system of claim 1, wherein the order information comprises an investor identity, a share price, and a quantity of shares to be purchased at the share price.

7. A method for confidential entry of orders into an order entry system to purchase shares of a company in an equity offering, comprising the steps of:
creating a transaction that will be an equity offering for shares of a company;
receiving by an order entry module the orders to purchase shares of the company in the equity offering transaction, the orders comprising order information and originating from one or more computers that are each associated with an investor type of party to the equity offering transaction; and
preventing via a security module communication of the order information to at least one computer that is associated with a sales person type of party to the equity offering transaction,
wherein the order entry module and the security module are implemented in a computer system that comprises instructions stored in a machine-readable medium and a processor that executes the instructions.

8. The method of claim 7, further comprising the step of storing the order information in a storage device.

9. The method of claim 7, wherein the security module performs the preventing step based on access rights associated with the sales person type of party.

10. The method of claim 7, further comprising the step of presenting by an order book module the order information to one or more computers that are each associated with a member of a management/equity capital markets company team for the equity offering transaction,
wherein the order book module is implemented in the computer system that comprises instructions stored in a machine-readable medium and a processor that executes the instructions.

11. The method of claim 7, further comprising the steps of:
storing in a database access rights that are associated with each type of party to the equity offering transaction; and
determining by the security module prior to the receiving step to allow the order entry module to communicate with the one or more computers that are each associated with the investor type of party based on the access rights stored in the database for the investor type of party.

12. The method of claim 7, further comprising the steps of:
storing in a database access rights that are associated with each type of party to the equity offering transaction; and
determining by the security module prior to the preventing step to prevent communication with the one or more computers that are each associated with the sales person type of party based on the access rights stored in the database for the sales person type of party.

13. The method of claim 7, wherein the equity offering transaction is an initial public offering.

14. The method of claim 7, wherein the order information comprises an investor identity, a share price, and a quantity of shares to be purchased at the share price.

15. A system for confidential entry of orders to purchase shares of a company in an equity offering, comprising:
means for receiving the orders to purchase shares of a company in an equity offering transaction, the orders comprising order information and originating from one or more computers that are each associated with an investor type of party to the equity offering transaction; and
means for accessing the order information in the means for storing and for communicating the order information to one or more computers that are each associated with a member of a management/equity capital markets company team for the equity offering transaction; and
security means for (1) allowing the means for receiving to communicate with the one or more computers that are each associated with the investor type of party to thereby receive the orders, (2) preventing communication of the order information to at least one computer that is associated with a sales person type of party to the equity offering transaction, and (3) allowing the means for communicating to communicate the order information to the one or more computers that are each associated with a member of the management/equity capital markets company team.

16. The system of claim 15, wherein the means for storing stores access rights that are associated with each type of party to the equity offering transaction, and wherein the security means comprises means for reading the access rights associated with the investor type of party to determine to allow the means for receiving orders to communicate with the one or more computers that are each associated with the investor type of party and means for reading the access rights associated with the sales person type of party to determine to prevent communication of the order information to at least one computer that is associated with the sales person type of party.

17. The system of claim 15, further comprising a means for storing, wherein the means for receiving stores the order information in the means for storing.

18. The system of claim 15, wherein the equity offering transaction comprises an auction format, and wherein the orders comprise an auction bid format.

19. The system of claim 15, wherein the equity offering transaction is an initial public offering.

20. The system of claim 15, wherein the order information comprises an investor identity, a share price, and a quantity of shares to be purchased at the share price.

21. A computer program product, comprising:
a computer-readable medium having computer-readable program code embodied therein for confidential entry of orders to purchase shares of a company in an equity offering transaction, the computer-readable medium comprising:
computer-readable program code for receiving the orders to purchase shares of the company in the equity offering transaction, each of the orders comprising order information and originating from one or more computers that are each associated with an investor type of party to the equity offering transaction;
computer-readable program code for preventing communication of the order information to at least one computer that is associated with a sales person type of party to the equity offering transaction; and
computer-readable program code allowing the communication with the one or more computers that are each associated with the investor type of party to thereby receive the orders.

22. The computer program product of claim 21, wherein the computer-readable medium further comprises:
computer-readable program code for presenting the order information to one or more computers that are each associated with a member of a management/equity capital markets company team for the equity offering transaction; and
computer-readable program code for allowing communication with the one or more computers that are each associated with a member of the management/equity capital markets company team to thereby present the order information.

23. The computer program product of claim 21, wherein the computer-readable medium further comprises:
computer-readable program code for storing access rights that are associated with each type of party to the equity offering transaction; and
computer-readable program code for determining prior to receiving the orders to allow communication with the one or more computers that are each associated with the investor type of party based on the access rights for the investor type of party.

24. The computer program product of claim 21, further comprising:
computer-readable program code for storing access rights that are associated with each type of party to the equity offering transaction; and
computer-readable program code for determining to prevent the communication with the one or more computers that are each associated with the sales person type of party based on the access rights for the sales person type of party.

25. The computer program product of claim 21, wherein the equity offering transaction is an initial public offering.

26. The computer program product of claim 21, wherein the computer-readable medium further comprises computer-readable program code for storing the order information.

27. The computer program product of claim 21, wherein the order information comprises an investor identity, a share price, and a quantity of shares to be purchased at the share price.
